(19) United States
(12) Patent Application Publication
(10) Pub. No.: US 2025/0159705 A1
(43) Pub. Date: May 15, 2025

(54) SUPPORT OF MULTI-PANEL UPLINK TRANSMISSION

(71) Applicant: LENOVO (BEIJING) LIMITED, BEIJING (CN)

(72) Inventor: BINGCHAO LIU, BEIJING (CN)

(21) Appl. No.: 18/834,601

(22) PCT Filed: Jan. 30, 2022
(86) PCT No.: PCT/CN2022/075188

§ 371 Date: Jul. 30, 2024

(51) Int. Cl. H04W 72/51; H04L 1/1812; H04L 5/00; H04W 16/28; H04W 72/1268; H04W 72/231

(52) U.S. Cl. CPC H04W 72/51; H04L 1/1812; H04L 5/0051; H04L 5/0053; H04W 16/28; H04W 72/1268; H04W 72/231

(57) ABSTRACT

Methods and apparatuses for support of multi-panel uplink (UL) transmission are disclosed. In one embodiment, a user equipment (UE) comprises a processor and a transceiver coupled to the processor, wherein the processor is configured to cause the UE to: transmit, via the transceiver, one or two UE capability value set index or indices in a beam report, where each UE capability value set index indicates a supported UE capability value set; and determine Sounding Reference Signal (SRS) resource(s) used for codebook transmission after receiving an acknowledgement for the transmitted UE capability value set index or indices.

### FIELD

The subject matter disclosed herein generally relates to wireless communications, and more particularly relates to methods and apparatuses for support of multi-panel UL transmission.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), Transmitter (TX), Receiver (RX), Sounding Reference Signal (SRS), SRS resource indicator (SRI), Physical Uplink Shared Channel (PUSCH), Downlink Control Information (DCI), codebook (CB), Physical Uplink Control Channel (PUCCH), Physical Downlink Control Channel (PDCCH), New data indicator (NDI), Hybrid Automatic Repeat request (HARQ), PUCCH resource ID (PRI), transmitted precoding matrix indicator (TPMI), sub-carrier space (SCS).

A working assumption has achieved that the UE can report multiple UE capability value sets each of which at least includes the supported maximum number of SRS ports. Each UE capability value set at least represents a UE panel type. It means that UE only needs to report the number of different UE panel types and the parameters for each UE panel type (e.g. the supported maximum number of SRS ports).

The UE can report the UE capability value set index to the gNB in L1 beam report. The UE capability value set indicated by the reported UE capability value set index indicates a UE panel type for the subsequent UL transmission. It means that if the UE wants to change its panel type for the UL transmission, new UE capability value set index shall be reported to the gNB.

It is yet unknown how the network side (e.g. gNB) indicates an acknowledgement to the UE for the report of the UE capability value set index and what are the corresponding UE and gNB behaviors.

This disclosure targets supporting multi-panel UL transmission, especially on how to report panel related information and the corresponding UE and gNB behaviors.

### BRIEF SUMMARY

Methods and apparatuses for support of multi-panel UL transmission are disclosed.

In one embodiment, a UE comprises a processor; and a transceiver coupled to the processor, wherein the processor is configured to transmit, via the transceiver, one or two UE capability value set index or indices in a beam report, where each UE capability value set index indicates a supported UE capability value set; and determine SRS resource(s) used for codebook transmission after receiving an acknowledgement for the transmitted UE capability value set index or indices.

In one embodiment, when the beam report is carried by a PUSCH transmission, the acknowledgement for the transmitted UE capability value set index or indices is received when a PDCCH transmission with a DCI format scheduling a PUSCH transmission with a same HARQ process number as for the PUSCH transmission carrying the beam report and having a toggled NDI field value is received.

In another embodiment, when the beam report is carried by a PUCCH transmission, the acknowledgement for the transmitted UE capability value set index or indices is received when a PDCCH transmission with a DCI format scheduling a PUCCH transmission with a same PUCCH resource ID as the PUCCH transmission carrying the beam report within a time window beginning from the last symbol of the PUCCH transmission carrying the reported UE capability value set index or indices is received.

In some embodiment, after K symbols or K′ ms from a last symbol of PDCCH transmission containing the acknowledgement for the transmitted UE capability value set index or indices, where K or K′ is a specified value or a configured value, if one SRS resource set for codebook containing multiple SRS resources with different numbers of SRS ports is configured, the SRS resource(s) with the same number(s) of SRS ports as that or those indicated in the UE capability value set(s) indicated by the one or two UE capability value set index or indices are activated, and the other SRS resources within the one SRS resource set are deactivated; and if multiple SRS resource sets for codebook, each of which is with a different number of SRS ports, are configured, the SRS resources within the SRS resource set(s) with the same number(s) of SRS ports as that or those indicated in the UE capability value sets indicated by the one or two UE capability value set index or indices are activated, and the SRS resources within other SRS resource set(s) are deactivated. The processor may further be configured to report, via the transceiver, a capability on the value of K or K′. The value of K may be reported per SCS. A bitwidth of SRS resource indicator field in DCI format 0_1 or 0_2 indicating SRS resource used for the scheduled or activated PUSCH transmission may be determined by the total number of activated SRS resources, or may be determined by the total number of SRS resources within the configured SRS resource set(s) for codebook. The processor may be configured to only expect to receive DCI format 0_1 or 0_2 indicating an SRI codepoint that is mapped to an activated SRS resource. The SRI codepoint(s) indicated by DCI format 0_1 or 0_2 shall be mapped to the activated SRS resource(s).

In some embodiment, the method may further comprise transmitting one or multiple supported UE capability value sets, wherein each supported UE capability value set indicates a maximum number of supported SRS ports

In another embodiment, a method at a UE comprises transmitting one or two UE capability value set index or indices in a beam report, where each UE capability value set index indicates a supported UE capability value set; and determining SRS resource(s) used for codebook transmission after receiving an acknowledgement for the transmitted UE capability value set index or indices.

In still another embodiment, a base unit comprises a processor; and a transceiver coupled to the processor, wherein the processor is configured to receive, via the transceiver, one or two UE capability value set index or indices in a beam report, where each UE capability value set index indicates a supported UE capability value set; and determine SRS resource(s) used for codebook transmission after transmitting an acknowledgement for the received UE capability value set index or indices.

In yet another embodiment, a method of a base unit comprises receiving one or two UE capability value set index or indices in a beam report, where each UE capability value set index indicates a supported UE capability value set; and determining SRS resource(s) used for codebook transmission after transmitting an acknowledgement for the received UE capability value set index or indices.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example of procedures of the present invention;

FIG. 2 is a schematic flow chart diagram illustrating an embodiment of a method;

FIG. 3 is a schematic flow chart diagram illustrating an embodiment of another method; and

FIG. 4 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

As described in the background part, it was agreed that, when multiple panels with different panel types are equipped by the UE, a UE can report multiple UE capability value sets, each of which corresponds to a UE panel type. The UE panel type (or abbreviated as panel type) at least includes the maximum number of supported SRS ports. An example of multiple UE capability value sets is listed as follows:
UE capability value set #1:={maximum number of supported SRS ports=1 (UE panel type #1)};
UE capability value set #2:={maximum number of supported SRS ports=2 (UE panel type #2)};
UE capability value set #3:={maximum number of supported SRS ports=4 (UE panel type #3)};
UE capability value set #4:={maximum number of supported SRS ports=8 (UE panel type #4)}.

The gNB shall assume the same UE capability on ‘fully AndPartialAndNonCoherent’, ‘partialAndNonCoherent’ or ‘nonCoherent’ for each UE capability value set. For codebook based UL transmission, the UL precoder for PUSCH transmission is selected from a set of specified precoders, which are called as codebook. The UE determines its codebook subsets based on the indicated TPMI and upon the reception of higher layer parameter codebookSubset, which is a higher layer parameter to indicate that only a sub-set of precoders can be selected, in PUSCH configuration for PUSCH associated with DCI format 0_1 and codebookSubsetDCI-0-2 in PUSCH configuration for PUSCH associated with DCI format 0_2 which may be configured with ‘fully AndPartialAndNonCoherent’, ‘partialAndNonCoherent’ or ‘nonCoherent’ depending on the UE capability. The ‘fully AndPartialAndNonCoherent’ means that all of the SRS ports corresponding to a UE panel can be coherently transmitted. The ‘partialAndNonCoherent’ means that part of the SRS ports corresponding to a UE panel can be coherently transmitted, for example, port 0 and port 2 can be coherently transmitted, and port 1 and port 3 can be coherently transmitted, while port 0 (or port 2) and port 1 (or port 3) cannot be coherently transmitted. The ‘noncoherent’ means that all of the SRS ports corresponding to a UE panel cannot be coherently transmitted.

The UE may report all its supported UE capability value sets to the gNB, e.g. by RRC signaling.

Each UE capability value set has a UE capability value set index.

For example, if one UE reports a total of four (4) UE capability value sets, four indices 00, 01, 10 and 11 can be used to indicate the four (4) UE capability value sets. For example, if four (4) UE capability value sets are the above-mentioned UE capability value set #1, UE capability value set #2, UE capability value set #3, and UE capability value set #4, UE capability value set index 00 may indicate UE capability value set #1; UE capability value set index 01 may indicate UE capability value set #2; UE capability value set index 10 may indicate UE capability value set #3; and UE capability value set index 11 may indicate UE capability value set #4.

For another example, if another UE reports a total of two (2) UE capability value sets, two indices 0 and 1 can be used to indicate the two (2) UE capability value sets. For example, if the two (2) UE capability value sets are the above-mentioned UE capability value set #2 and UE capability value set #3, UE capability value set index 0 may indicate UE capability value set #2; and UE capability value set index 1 may indicate UE capability value set #3.

It can be seen that, depending on the UE capability value sets reported by the UE, a UE capability value set index may indicate different UE capability value sets. In other words, the UE capability value set index is per UE.

The reported UE capability value sets are a kind of UE capability.

The UE is necessary to report, from the reported UE capability value sets, one or multiple (e.g. one or two) UE capability value sets for use in UL transmission. This can be done by reporting the UE capability value set index or indices of the UE capability value sets for use in UL transmission.

A first embodiment relates to reporting the UE capability value set index.

For codebook (CB) based PUSCH transmission, the gNB may configure one SRS resource set for CB or multiple SRS resource sets for CB. Multiple SRS resource sets, each of which contains one or more SRS resources, can be configured for a UE in a BWP of a cell, and different SRS resource sets are configured for different usages. SRS resource set for codebook is used for codebook based PUSCH transmission, where a set of UL precoders are specified corresponding to different numbers of antenna ports. The precoder used for the scheduled PUSCH transmission is based on the UL channel estimation based on the SRS resource used for codebook sending from UE to gNB.

If one SRS resource set for CB is configured, multiple SRS resources contained in the one SRS resource set are with different numbers of SRS ports if multiple UE capability value sets are supported by the UE. For example, eight (8) SRS resources are contained in the one SRS resource set for CB: SRS resource #1 and SRS resource #2 are with 1 SRS port; SRS resource #3 and SRS resource #4 are with 2 SRS ports; SRS resource #5 and SRS resource #6 are with 4 SRS ports; and SRS resource #7 and SRS resource #8 are with 8 SRS ports.

If multiple SRS resource sets for CB are configured, all SRS resources within a same SRS resource set are with a same number of SRS ports. SRS resources from different SRS resource sets are with different numbers of SRS ports. For example, four (4) SRS resource sets for CB, each of which contains two (2) SRS resources, are configured: SRS resource #1 and SRS resource #2 contained in SRS resource set #1 are with 1 SRS port; SRS resource #3 and SRS resource #4 contained in SRS resource set #2 are with 2 SRS ports; SRS resource #5 and SRS resource #6 contained in SRS resource set #3 are with 4 SRS ports; and SRS resource #7 and SRS resource #8 contained in SRS resource set #4 are with 8 SRS ports.

The UE may report one or two UE capability value set index or indices to the gNB in a beam report. For example, if the UE does not support simultaneous multi-panel UL transmission, i.e., only one UE panel can be used for UL transmission at a time instant, one (i.e. a single) UE capability value set index is reported in the beam report. If the UE support simultaneous multi-panel UL transmission, two (i.e. a pair of) UE capability value set indices can be reported in the beam report. The reported UE capability value set index or indices indicate that the SRS resources contained in the configured SRS resource set(s) for CB with the same number(s) of SRS ports as that or those indicated by the reported UE capability value set index or indices are activated.

For example, if four indices 00, 01, 10 and 11 are respectively used to indicate the four (4) UE capability value sets (e.g. UE capability value set #1, UE capability value set #2, UE capability value set #3, and UE capability value set #4), if the reported UE capability value set index for use in UL transmission is 01 (i.e. UE capability value set #2, which refers to maximum number of supported SRS ports=2, is reported), only the SRS resource #3 and SRS resource #4 that are with 2 SRS ports are activated for use in UL transmission, while the other SRS resources (i.e. SRS resource #1 and SRS resource #2 that are with 1 SRS port; SRS resource #5 and SRS resource #6 that are with 4 SRS ports; and SRS resource #7 and SRS resource #8 that are with 8 SRS ports) are deactivated. If the reported UE capability value set indices for use in UL transmission are 01 and 10 (i.e. UE capability value set #2, which refers to maximum number of supported SRS ports=2, and UE capability value set #3, which refers to maximum number of supported SRS ports=4, are reported), only the SRS resource #3 and SRS resource #4 that are with 2 SRS ports and SRS resource #5 and SRS resource #6 that are with 4 SRS ports are activated for use in UL transmission, while the other SRS resources (i.e. SRS resource #1 and SRS resource #2 that are with 1 SRS port; and SRS resource #7 and SRS resource #8 that are with 8 SRS ports) are deactivated.

Whether UE capability value set index can be reported in a beam report (which is configured by CSI report configuration configured by RRC signaling CSI-ReportConfig IE) is configured by a higher layer parameter per CSI-ReportConfig.

If the panel type is changed, the gNB and UE need to have a common understanding on the updated panel type. It means that the gNB and UE should have a common understanding on which UE capability value set indicates which UE panel type.

A second embodiment relates to how to indicate acknowledgement from gNB to UE for UE capability value set index reporting.

UE capability value set index (indices) is/are reported in a beam report, which can be carried by a PUSCH transmission or a PUCCH transmission. Accordingly, two different acknowledgement indication mechanisms are proposed.

When the reported UE capability value set index (indices) is/are contained in a beam report carried by a PUSCH transmission, UE shall assume the reported UE capability value set index (indices) is/are successfully received by the gNB when the UE receives a PDCCH transmission with a DCI format scheduling a PUSCH transmission with a same HARQ process number as for the PUSCH transmission carrying the beam report (i.e. carrying the reported UE capability value set index (indices)) and having a toggled NDI field value.

When the reported UE capability value set index or indices is/are contained in a beam report carried by a PUCCH transmission, UE shall assume the reported UE capability value set index or indices is/are successfully received by the gNB when the UE receives a PDCCH transmission with a DCI format scheduling a PUCCH transmission with a same PUCCH resource ID (PRI) as the PUCCH transmission carrying the beam report (i.e. carrying the reported UE capability value set index or indices) within a time window beginning from the last symbol of the PUCCH transmission carrying the reported UE capability value set index or indices, where the length or the duration of the time window can be a specified value or a value configured according to UE capability. If the time window is not specified or configured, the default length or duration is infinite, i.e. UE shall assume the reported UE capability value set index or indices is/are successfully received by the gNB when the UE receives a PDCCH transmission with a DCI format scheduling a PUCCH transmission with a same PUCCH resource ID (PRI) as the PUCCH transmission carrying the beam report (i.e. carrying the reported UE capability value set index or indices).

A third embodiment relates to UE and gNB behaviors after UE capability value set index or indices is/are reported and acknowledgement for the receipt of the reported UE capability value set index or indices by gNB is received.

After K symbols or K′ ms from a last symbol of the PDCCH transmission confirming the reported UE capability value set index or indices is/are successfully received by the gNB (in particular, from a last symbol of the PDCCH transmission with a DCI format scheduling a PUSCH transmission with a same HARQ process number as for the PUSCH transmission carrying the beam report (i.e. carrying the reported UE capability value set index or indices) and having a toggled NDI field value, or from a last symbol of the PDCCH transmission with a DCI format scheduling a PUCCH transmission with a same PUCCH resource ID as the PUCCH transmission carrying the beam report (i.e. carrying the reported UE capability value set index or indices) within a time window beginning from the last symbol of the PUCCH transmission carrying the reported UE capability value set index or indices), the SRS resources contained in the configured SRS resource set(s) for CB with the same number(s) of SRS ports as that or those indicated by the reported UE capability value set index or indices are activated, while the other SRS resources contained in the configured SRS resource set(s) for CB (i.e. with different number(s) of SRS ports from that or those indicated by the reported UE capability value set index or indices) are deactivated. The value of K or K′ can be a specified value or a value configured according to UE capability. If K is defined as the number of symbols, it is reported per SCS and is configured per SCS.

The UE only needs to transmit the activated SRS resource(s) and shall not transmit the deactivated SRS resources.

Case 1: When one SRS resource set for CB containing multiple SRS resources with different numbers of SRS ports is configured, after K symbols or K′ ms from a last symbol of the PDCCH transmission confirming the reported UE capability value set index or indices is/are successfully received by the gNB, the UE shall assume only the SRS resource(s) with the same number(s) of SRS ports as that or those indicated by the reported UE capability value set index or indices are activated, and the other SRS resources (i.e. with different number(s) of SRS ports from that or those indicated by the reported UE capability value set index or indices) in the configured one SRS resource set are deactivated.

When a DCI format 0_1 or 0_2 scheduling or activating a PUSCH transmission, the DCI format 0_1 or 0_2 contains an SRS resource indicator (SRI) field indicating SRS resource used for the scheduled or activated PUSCH transmission.

In Case 1, the bitwidth of the SRS Resource Indicator (SRI) field contained in DCI format 0_1 or 0_2 scheduling or activating PUSCH transmission can be determined by two alternative methods:

Method 1: determined by the total number of SRS resources with the same number(s) of SRS ports as that or those indicated by the reported UE capability value set index or indices (i.e. the total number of activated SRS resources). The mapping between the SRI codepoint, i.e., the SRI field value, and the SRS resource shall be updated accordingly.

Method 2: determined by the total number of SRS resources within the one SRS resource set for CB. The UE does not expect any SRS resource with a different number of SRS ports from that or one of those indicated by the reported UE capability value set index or indices is indicated in the DCI scheduling or activating a PUSCH transmission.

For example, it is assumed that eight (8) SRS resources (e.g. SRS resource #1, SRS resource #2, SRS resource #3, SRS resource #4, SRS resource #5, SRS resource #6, SRS resource #7 and SRS resource #8) are contained in the one SRS resource set for CB, and only two (2) SRS resources (e.g. SRS resource #3 and SRS resource #4) are with the same number of SRS ports as that indicated by the reported UE capability value set index.

If method 1 is adopted, the bitwidth of the SRI field contained in DCI format 0_1 or 0_2 scheduling or activating PUSCH transmission is determined by the total number of activated SRS resources (e.g. 2). For example, the bitwidth of SRI field can be 1 (=log₂ 2) bit (e.g. codepoints 0 and 1), in which lower (higher) codepoint indicates activated SRS resource with lower (higher) index, e.g. codepoint 0 indicates SRS resource #3 and codepoint 1 indicates SRS resource #4.

If method 2 is adopted, the bitwidth of SRI field contained in DCI format 0_1 or 0_2 scheduling or activating PUSCH transmission is determined by the total number of SRS resources within the one SRS resource set for CB (e.g. 8). For example, the bitwidth of SRI field can be 3 (=log₂ 8) bits (e.g. codepoint 000, 001, 010, 011, 100, 101, 110 and 111), in which codepoint 010 indicates SRS resource #3, and codepoint 011 indicates SRS resource #4. The UE only expects to receive DCI format 0_1 or 0_2 including SRI field with codepoint of 010 or 011, but does not expect to receive DCI format 0_1 or 0_2 including SRI field with any of codepoints 000, 001, 100, 101, 110 and 111.

In case 1, if method 2 is adopted, another acknowledgement mechanism is proposed. If the UE receives a PDCCH transmission with a DCI format indicating a SRS resource with the same number of SRS ports as that or one of those indicated by the reported UE capability value set index or indices (which is different from the previously activated SRS resource), the UE shall assume reported UE capability value set index or indices is/are successfully received by the gNB, no matter whether the reported UE capability value set index or indices is/are contained in a beam report carried by a PUCCH transmission or a PUSCH transmission.

Case 2: When multiple SRS resource sets for CB, in which all SRS resources within a same SRS resource set are with a same number of SRS ports and SRS resources from different SRS resource sets are with different numbers of SRS ports, are configured, after K symbols or K′ ms from a last symbol of the PDCCH transmission confirming the reported UE capability value set index or indices is/are successfully received by the gNB, the UE shall assume that only the SRS resource set(s) with the same number(s) of SRS ports as that or those indicated by the reported UE capability value set index or indices are activated, and the SRS resources within other SRS resource set(s) (i.e. with different number(s) of SRS ports from that or those indicated by the reported UE capability value set index or indices) are deactivated.

In Case 2, the bitwidth of the SRI field contained in DCI format 0_1 or 0_2 scheduling or activating PUSCH transmission is determined by the total number of SRS resources within the activated SRS resource set(s). Each SRI codepoint corresponds to one of the SRS resource within the activated SRS resource set(s).

For example, it is assumed that four (4) SRS resource sets for CB, each of which contains two (2) SRS resources, are configured: SRS resource #1 and SRS resource #2 contained in SRS resource set #1 are with 1 SRS port; SRS resource #3 and SRS resource #4 contained in SRS resource set #2 are with 2 SRS ports; SRS resource #5 and SRS resource #6 contained in SRS resource set #3 are with 4 SRS ports; and SRS resource #7 and SRS resource #8 contained in SRS resource set #4 are with 8 SRS ports. Only SRS resource set #2 (i.e. SRS resource #3 and SRS resource #4) are with the same number of SRS ports as that indicated by the reported UE capability value set index. That is, only SRS resource set #2 (i.e. SRS resource #3 and SRS resource #4) are activated. The bitwidth of the SRI field contained in DCI format 0_1 or 0_2 scheduling or activating PUSCH transmission is determined by the total number of SRS resources within the activated SRS resource set (e.g. 2). For example, the bitwidth of SRI field can be 1 (=log₂ 2) bit (e.g. codepoints 0 and 1), in which lower (higher) codepoint indicates SRS resource with lower (higher) index in the activated SRS resource set, e.g. codepoint 0 indicates SRS resource #3 and codepoint 1 indicates SRS resource #4.

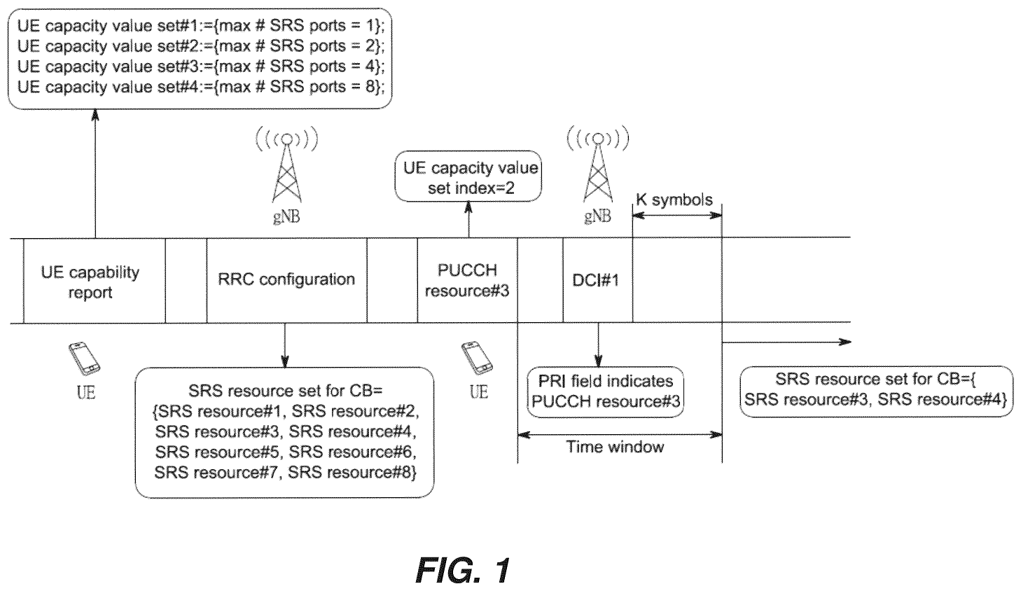

FIG. 1 illustrates an example of the procedures of the invention.

At first, UE reports (i.e. transmits to gNB) the supported UE capability value sets, e.g.
UE capability value set #1:={maximum number of supported SRS ports=1};
UE capability value set #2:={maximum number of supported SRS ports=2};
UE capability value set #3:={maximum number of supported SRS ports=4};
UE capability value set #4:={maximum number of supported SRS ports=8}.

The gNB transmits an RRC configuration of the SRS resource set for codebook. In the example of FIG. 1, one SRS resource set for CB is configured. The one SRS resource set contains eight (8) SRS resources with different numbers of SRS ports: SRS resource #1 and SRS resource #2 are with 1 SRS port; SRS resource #3 and SRS resource #4 are with 2 SRS ports; SRS resource #5 and SRS resource #6 are with 4 SRS ports; and SRS resource #7 and SRS resource #8 are with 8 SRS ports.

The UE reports one UE capability value set index, e.g. UE capability value set index=2 (indicating UE capability value set #2) in a PUCCH resource (e.g PUCCH resource #3).

The gNB acknowledges reception of PUCCH resource #3 by transmitting DCI #1, the PUCCH resource ID (PRI) field of which indicates PUCCH resource #3 within a time window.

After K symbols from the last symbol of PDCCH transmission carrying DCI #1, only the SRS resources (i.e. SRS resource #3 and SRS resource #4) with the same number of SRS ports (i.e. with two SRS ports) as that indicated by the reported UE capability value set index (i.e. UE capability value set index=2 indicating UE capability value set #2) are activated.

When only SRS resource #3 and SRS resource #4 are activated, the UE expects to receive DCI for PUSCH scheduling containing a SRI field with a codepoint mapped only to SRS resource #3 or SRS resource #4.

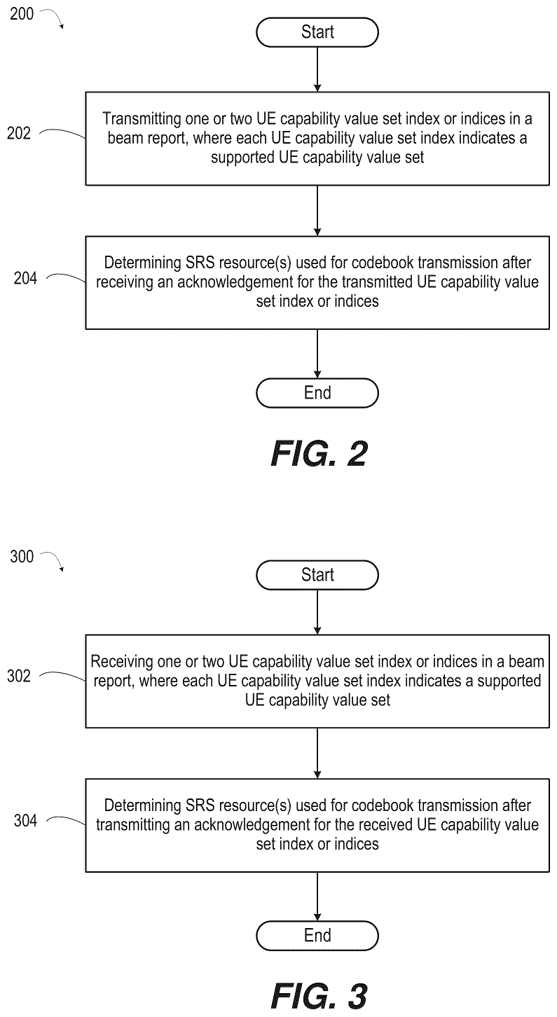

FIG. 2 is a schematic flow chart diagram illustrating an embodiment of a method 200 according to the present application. In some embodiments, the method 200 is performed by an apparatus, such as a remote unit (e.g. UE). In certain embodiments, the method 200 may be performed by a processor executing program code, for example, a microcontroller, a microprocessor, a CPU, a GPU, an auxiliary processing unit, a FPGA, or the like.

The method 200 is a method of a UE, comprising: 202 transmitting one or two UE capability value set index or indices in a beam report, where each UE capability value set index indicates a supported UE capability value set; and 204 determining SRS resource(s) used for codebook transmission after receiving an acknowledgement for the transmitted UE capability value set index or indices.

In one embodiment, when the beam report is carried by a PUSCH transmission, the acknowledgement for the transmitted UE capability value set index or indices is received when a PDCCH transmission with a DCI format scheduling a PUSCH transmission with a same HARQ process number as for the PUSCH transmission carrying the beam report and having a toggled NDI field value is received.

In another embodiment, when the beam report is carried by a PUCCH transmission, the acknowledgement for the transmitted UE capability value set index or indices is received when a PDCCH transmission with a DCI format scheduling a PUCCH transmission with a same PUCCH resource ID as the PUCCH transmission carrying the beam report within a time window beginning from the last symbol of the PUCCH transmission carrying the reported UE capability value set index or indices is received.

In some embodiment, after K symbols or K′ ms from a last symbol of PDCCH transmission containing the acknowledgement for the transmitted UE capability value set index or indices, where K or K′ is a specified value or a configured value, if one SRS resource set for codebook containing multiple SRS resources with different numbers of SRS ports is configured, the SRS resource(s) with the same number(s) of SRS ports as that or those indicated in the UE capability value set(s) indicated by the one or two UE capability value set index or indices are activated, and the other SRS resources within the one SRS resource set are deactivated; and if multiple SRS resource sets for codebook, each of which is with a different number of SRS ports, are configured, the SRS resources within the SRS resource set(s) with the same number(s) of SRS ports as that or those indicated in the UE capability value sets indicated by the one or two UE capability value set index or indices are activated, and the SRS resources within other SRS resource set(s) are deactivated. The method may further comprise reporting a capability on the value of K or K′. The value of K may be reported per SCS. A bitwidth of SRS resource indicator field in DCI format 0_1 or 0_2 indicating SRS resource used for the scheduled or activated PUSCH transmission may be determined by the total number of activated SRS resources, or may be determined by the total number of SRS resources within the configured SRS resource set(s) for codebook. The method may further comprise only expecting to receive DCI format 0_1 or 0_2 indicating an SRI codepoint that is mapped to an activated SRS resource. The SRI codepoint(s) indicated by DCI format 0_1 or 0_2 shall be mapped to the activated SRS resource(s).

The method may further comprise transmitting one or multiple supported UE capability value sets, wherein each supported UE capability value set indicates a maximum number of supported SRS ports.

FIG. 3 is a schematic flow chart diagram illustrating an embodiment of a method 300 according to the present application. In some embodiments, the method 300 is performed by an apparatus, such as a base unit. In certain embodiments, the method 300 may be performed by a processor executing program code, for example, a microcontroller, a microprocessor, a CPU, a GPU, an auxiliary processing unit, a FPGA, or the like.

The method 300 may comprise 302 receiving one or two UE capability value set index or indices in a beam report, where each UE capability value set index indicates a supported UE capability value set; and 304 determining SRS resource(s) used for codebook transmission after transmitting an acknowledgement for the received UE capability value set index or indices.

In one embodiment, when the beam report is carried by a PUSCH transmission, the acknowledgement for the received UE capability value set index or indices is transmitted when a PDCCH transmission with a DCI format scheduling a PUSCH transmission with a same HARQ process number as for the PUSCH transmission carrying the beam report and having a toggled NDI field value is transmitted.

In another embodiment, when the beam report is carried by a PUCCH transmission, the acknowledgement for the received UE capability value set index or indices is transmitted when a PDCCH transmission with a DCI format scheduling a PUCCH transmission with a same PUCCH resource ID as the PUCCH transmission carrying the beam report within a time window beginning from the last symbol of the PUCCH transmission carrying the reported UE capability value set index or indices is transmitted.

In some embodiment, after K symbols or K′ ms from a last symbol of PDCCH transmission containing the acknowledgement for the received UE capability value set index or indices, where K or K′ is a specified value or a configured value, if one SRS resource set for codebook containing multiple SRS resources with different numbers of SRS ports is configured, the SRS resource(s) with the same number(s) of SRS ports as that or those indicated in the UE capability value set(s) indicated by the one or two UE capability value set index or indices are activated, and the other SRS resources within the one SRS resource set are deactivated; and if multiple SRS resource sets for codebook, each of which is with a different number of SRS ports, are configured, the SRS resources within the SRS resource set(s) with the same number(s) of SRS ports as that or those indicated in the UE capability value sets indicated by the one or two UE capability value set index or indices are activated, and the SRS resources within other SRS resource set(s) are deactivated. The method may further comprise receiving a capability on the value of K or K′. The value of K may be received per SCS. A bitwidth of SRS resource indicator field in DCI format 0_1 or 0_2 indicating SRS resource used for the scheduled or activated PUSCH transmission may be determined by the total number of activated SRS resources, or may be determined by the total number of SRS resources within the configured SRS resource set(s) for codebook. The method further comprises transmitting DCI format 0_1 or 0_2 only indicating an SRI codepoint that is mapped to an activated SRS resource. The SRI codepoint(s) indicated by DCI format 0_1 or 0_2 shall be mapped to the activated SRS resource(s).

The method may further comprise receiving one or multiple supported UE capability value sets, wherein each supported UE capability value set indicates a maximum number of supported SRS ports.

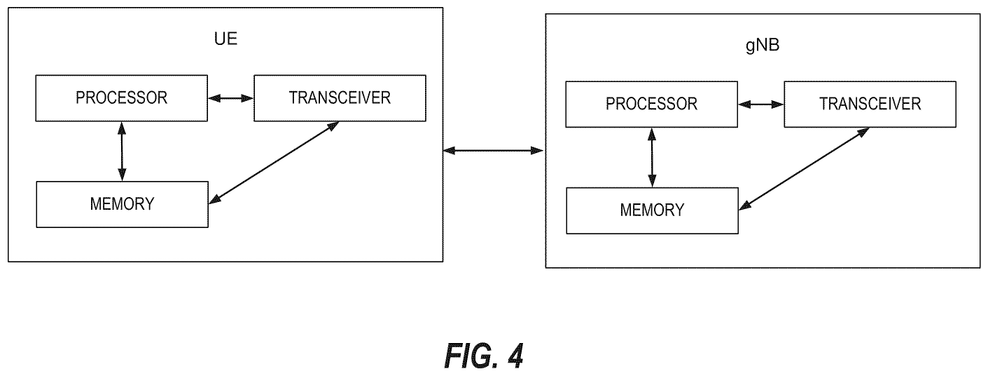

FIG. 4 is a schematic block diagram illustrating apparatuses according to one embodiment.

Referring to FIG. 4, the UE (i.e. the remote unit) includes a processor, a memory, and a transceiver. The processor implements a function, a process, and/or a method which are proposed in FIG. 2.

The UE comprises a processor; and a transceiver coupled to the processor, wherein the processor is configured to transmit, via the transceiver, one or two UE capability value set index or indices in a beam report, where each UE capability value set index indicates a supported UE capability value set; and determine SRS resource(s) used for codebook transmission after receiving an acknowledgement for the transmitted UE capability value set index or indices.

In one embodiment, when the beam report is carried by a PUSCH transmission, the acknowledgement for the transmitted UE capability value set index or indices is received when a PDCCH transmission with a DCI format scheduling a PUSCH transmission with a same HARQ process number as for the PUSCH transmission carrying the beam report and having a toggled NDI field value is received.

In another embodiment, when the beam report is carried by a PUCCH transmission, the acknowledgement for the transmitted UE capability value set index or indices is received when a PDCCH transmission with a DCI format scheduling a PUCCH transmission with a same PUCCH resource ID as the PUCCH transmission carrying the beam report within a time window beginning from the last symbol of the PUCCH transmission carrying the reported UE capability value set index or indices is received.

In some embodiment, after K symbols or K′ ms from a last symbol of PDCCH transmission containing the acknowledgement for the transmitted UE capability value set index or indices, where K or K′ is a specified value or a configured value, if one SRS resource set for codebook containing multiple SRS resources with different numbers of SRS ports is configured, the SRS resource(s) with the same number(s) of SRS ports as that or those indicated in the UE capability value set(s) indicated by the one or two UE capability value set index or indices are activated, and the other SRS resources within the one SRS resource set are deactivated; and if multiple SRS resource sets for codebook, each of which is with a different number of SRS ports, are configured, the SRS resources within the SRS resource set(s) with the same number(s) of SRS ports as that or those indicated in the UE capability value sets indicated by the one or two UE capability value set index or indices are activated, and the SRS resources within other SRS resource set(s) are deactivated. The processor may further be configured to report, via the transceiver, a capability on the value of K or K′. The value of K may be reported per SCS. A bitwidth of SRS resource indicator field in DCI format 0_1 or 0_2 indicating SRS resource used for the scheduled or activated PUSCH transmission may be determined by the total number of activated SRS resources, or may be determined by the total number of SRS resources within the configured SRS resource set(s) for codebook. The processor may be configured to only expect to receive DCI format 0_1 or 0_2 indicating an SRI codepoint that is mapped to an activated SRS resource. The SRI codepoint(s) indicated by DCI format 0_1 or 0_2 shall be mapped to the activated SRS resource(s).

The processor may further be configured to transmit, via the transceiver, one or multiple supported UE capability value sets, wherein each supported UE capability value set indicates a maximum number of supported SRS ports.

The gNB (i.e. the base unit) includes a processor, a memory, and a transceiver. The processor implements a function, a process, and/or a method which are proposed in FIG. 3.

The base unit comprises a processor; and a transceiver coupled to the processor, wherein the processor is configured to receive, via the transceiver, one or two UE capability value set index or indices in a beam report, where each UE capability value set index indicates a supported UE capability value set; and determine SRS resource(s) used for codebook transmission after transmitting an acknowledgement for the received UE capability value set index or indices.

In one embodiment, when the beam report is carried by a PUSCH transmission, the acknowledgement for the received UE capability value set index or indices is transmitted when a PDCCH transmission with a DCI format scheduling a PUSCH transmission with a same HARQ process number as for the PUSCH transmission carrying the beam report and having a toggled NDI field value is transmitted.

In another embodiment, when the beam report is carried by a PUCCH transmission, the acknowledgement for the received UE capability value set index or indices is transmitted when a PDCCH transmission with a DCI format scheduling a PUCCH transmission with a same PUCCH resource ID as the PUCCH transmission carrying the beam report within a time window beginning from the last symbol of the PUCCH transmission carrying the reported UE capability value set index or indices is transmitted.

In some embodiment, after K symbols or K′ ms from a last symbol of PDCCH transmission containing the acknowledgement for the received UE capability value set index or indices, where K or K′ is a specified value or a configured value, if one SRS resource set for codebook containing multiple SRS resources with different numbers of SRS ports is configured, the SRS resource(s) with the same number(s) of SRS ports as that or those indicated in the UE capability value set(s) indicated by the one or two UE capability value set index or indices are activated, and the other SRS resources within the one SRS resource set are deactivated; and if multiple SRS resource sets for codebook, each of which is with a different number of SRS ports, are configured, the SRS resources within the SRS resource set(s) with the same number(s) of SRS ports as that or those indicated in the UE capability value sets indicated by the one or two UE capability value set index or indices are activated, and the SRS resources within other SRS resource set(s) are deactivated. The processer may further be configured to receive, via the transceiver, a capability on the value of K or K′. The value of K may be received per SCS. A bitwidth of SRS resource indicator field in DCI format 0_1 or 0_2 indicating SRS resource used for the scheduled or activated PUSCH transmission may be determined by the total number of activated SRS resources, or may be determined by the total number of SRS resources within the configured SRS resource set(s) for codebook. The processer may be further configured to transmit, via the transceiver, DCI format 0_1 or 0_2 only indicating an SRI codepoint that is mapped to an activated SRS resource. The SRI codepoint(s) indicated by DCI format 0_1 or 0_2 shall be mapped to the activated SRS resource(s).

The processer may be further configured to receive, via the transceiver, one or multiple supported UE capability value sets, wherein each supported UE capability value set indicates a maximum number of supported SRS ports.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE) for wireless communication, the UE comprising:
a processor;
a memory coupled to the processor; and
a transceiver coupled to the processor, wherein the processor is configured to cause the UE to:
transmit, via the transceiver, one or two UE capability value set index or indices in a beam report, where each UE capability value set index indicates a supported UE capability value set; and
determine Sounding Reference Signal (SRS) resource(s) used for codebook transmission after receiving an acknowledgement for the transmitted UE capability value set index or indices.

2. The UE of claim 1, wherein, when the beam report is carried by a Physical Uplink Shared Channel (PUSCH) transmission, the acknowledgement for the transmitted UE capability value set index or indices is received when a Physical Downlink Control Channel (PDCCH) transmission with a Downlink Control Information (DCI) format scheduling a PUSCH transmission with a same Hybrid Automatic Repeat request (HARQ) process number as for the PUSCH transmission carrying the beam report and having a toggled New data indicator (NDI) field value is received.

3. The UE of claim 1, wherein, when the beam report is carried by a Physical Uplink Control Channel (PUCCH) transmission, the acknowledgement for the transmitted UE capability value set index or indices is received when a PDCCH transmission with a DCI format scheduling a PUCCH transmission with a same PUCCH resource ID as the PUCCH transmission carrying the beam report within a time window beginning from the last symbol of the PUCCH transmission carrying the reported UE capability value set index or indices is received.

4. The UE of claim 1, wherein, after K symbols or K′ ms from a last symbol of PDCCH transmission containing the acknowledgement for the transmitted UE capability value set index or indices, where K or K′ is a specified value or a configured value:
if one SRS resource set for codebook containing multiple SRS resources with different numbers of SRS ports is configured, the SRS resource(s) with the same number(s) of SRS ports as that or those indicated in the UE capability value set(s) indicated by the one or two UE capability value set index or indices are activated, and the other SRS resources within the one SRS resource set are deactivated; and
if multiple SRS resource sets for codebook, each of which is with a different number of SRS ports, are configured, the SRS resources within the SRS resource set(s) with the same number(s) of SRS ports as that or those indicated in the UE capability value sets indicated by the one or two UE capability value set index or indices are activated, and the SRS resources within other SRS resource set(s) are deactivated.

5. The UE of claim 4, wherein, a bitwidth of SRS resource indicator field in DCI format 0_1 or 0_2 indicating SRS resource used for the scheduled or activated PUSCH transmission is determined by the total number of activated SRS resources.

6. The UE of claim 4, wherein, a bitwidth of SRS resource indicator field in DCI format 0_1 or 0_2 indicating SRS resource used for the scheduled or activated PUSCH transmission is determined by the total number of SRS resources within the configured SRS resource set(s) for codebook.

7. The UE of claim 4, wherein, the SRI codepoint(s) indicated by DCI format 0_1 or 0_2 are mapped to the activated SRS resource(s).

8. The UE of claim 6, wherein, the processor is configured to only expect to receive, via the transceiver, DCI format 0_1 or 0_2 indicating an SRI codepoint that is mapped to an activated SRS resource.

9. The UE of claim 1, wherein, the processor is further configured to cause the UE to transmit, via the transceiver, one or multiple supported UE capability value sets, wherein each supported UE capability value set indicates a maximum number of supported SRS ports.

10. The UE of claim 5, wherein, the processor is further configured to cause the UE to report, via the transceiver, a capability on the value of K or K′.

11. The UE of claim 10, wherein, the value of K is reported per sub-carrier space (SCS).

12. A method for wireless communication by a user equipment (UE), the method comprising:
transmitting one or two UE capability value set index or indices in a beam report, where each UE capability value set index indicates a supported UE capability value set; and
determining Sounding Reference Signal (SRS) resource(s) used for codebook transmission after receiving an acknowledgement for the transmitted UE capability value set index or indices.

13.-15. (canceled)

16. The method of claim 12, further comprising transmitting one or multiple supported UE capability value sets, wherein each supported UE capability value set indicates a maximum number of supported SRS ports.

17. A processor for wireless communication, the processor configured for:
transmit, via the transceiver, one or two UE capability value set index or indices in a beam report, where each UE capability value set index indicates a supported UE capability value set; and
determine Sounding Reference Signal (SRS) resource(s) used for codebook transmission after receiving an acknowledgement for the transmitted UE capability value set index or indices.

18. The processor of claim 17, wherein, when the beam report is carried by a Physical Uplink Shared Channel (PUSCH) transmission, the acknowledgement for the transmitted UE capability value set index or indices is received when a Physical Downlink Control Channel (PDCCH) transmission with a Downlink Control Information (DCI) format scheduling a PUSCH transmission with a same Hybrid Automatic Repeat request (HARQ) process number as for the PUSCH transmission carrying the beam report and having a toggled New data indicator (NDI) field value is received.

19. The processor of claim 17, wherein, when the beam report is carried by a Physical Uplink Control Channel (PUCCH) transmission, the acknowledgement for the transmitted UE capability value set index or indices is received when a PDCCH transmission with a DCI format scheduling a PUCCH transmission with a same PUCCH resource ID as the PUCCH transmission carrying the beam report within a time window beginning from the last symbol of the PUCCH transmission carrying the reported UE capability value set index or indices is received.

20. The processor of claim 17, further configured to transmit at least one supported UE capability value set, wherein each supported UE capability value set indicates a maximum number of supported SRS ports.

21. A base unit for wireless communication, the base unit comprising:
a processor;
a memory coupled to the processor; and
a transceiver coupled to the processor, wherein the processor is configured to cause the base unit to:
receive, via the transceiver, one or two user equipment (UE) capability value set index or indices in a beam report, where each UE capability value set index indicates a supported UE capability value set; and
determine Sounding Reference Signal (SRS) resource(s) used for codebook transmission after transmitting an acknowledgement for the received UE capability value set index or indices.

22. The base unit of claim 21, wherein, when the beam report is carried by a Physical Uplink Shared Channel (PUSCH) transmission, the acknowledgement for the received UE capability value set index or indices is transmitted when a Physical Downlink Control Channel (PDCCH) transmission with a Downlink Control Information (DCI) format scheduling a PUSCH transmission with a same Hybrid Automatic Repeat request (HARQ) process number as for the PUSCH transmission carrying the beam report and having a toggled New data indicator (NDI) field value is transmitted.

23. The base unit of claim 21, wherein, when the beam report is carried by a Physical Uplink Control Channel (PUCCH) transmission, the acknowledgement for the received UE capability value set index or indices is transmitted when a PDCCH transmission with a DCI format scheduling a PUCCH transmission with a same PUCCH resource ID as the PUCCH transmission carrying the beam report within a time window beginning from the last symbol of the PUCCH transmission carrying the reported UE capability value set index or indices is transmitted.
